(19) United States
(12) Patent Application Publication
(10) Pub. No.: US 2002/0158122 A1
(43) Pub. Date: Oct. 31, 2002

(54) Method and system to interpret and manage different smart card data architectures

(76) Inventor: David Landis Fisher JR., Tega Cay, SC (US)

Correspondence Address: DAVID L. FISHER, CARDSMART TECHNOLOGIES INC., 1140 MOLOKAI DRIVE, TEGA CAY, SC, 29708, US

(21) Appl. No.: 10/133,421

(22) Filed: Apr. 27, 2002

Related U.S. Application Data
(60) Provisional application No. 60/287,260, filed on Apr. 30, 2001.

(51) Int. Cl. G06F 17/00

(52) U.S. Cl. 235/375

(57) ABSTRACT

As smart cards and related advanced tokens are introduced into the mainstream the lack of data architecture standards significantly limit interoperability between similar systems. This problem is compounded at the application level where it is almost impossible to read and interpret data from a smart card that has been created and issued by an unrelated source.

The organization of data elements and corresponding security on a smart card is typically dictated by an application. This invention discloses a system for describing these application specific characteristics in a portable mapping file called an application template. This application template describes the structure, security, and encoding of the data on a smart card. In a similar manner, the process of formatting smart cards is made easier as multiple data models can be managed through the use of these application templates.

Consider the problem that there are several approved data models for encoding cardholder information to a federal government employee ID smart card. In particular, the CAC structure is used primarily by the Department of Defense and the J8/GSA structure is preferred by most other federal government agencies. This invention would enable any federal government employee ID smart card to be read at any federal government location.

### RELATED APPLICATION

This application is a non-provisional application claiming benefit of U.S. Provisional Application Ser. No. 60/287,260, filed Apr. 30, 2001.

### RELATED APPLICATIONS

U.S. Pat. No. 6,213,392 Zuppicich

U.S. Pat. No. 6,199,762 Hohle

U.S. Pat. No. 5,889,941 Tushie, et al.

### FEDERAL SPONSORED R&D

None.

### FIELD OF THE INVENTION

The invention is related to portable programmable data storage devices collectively referred to as “chip” or smart cards. The chip is embedded within the card plastic and typically communicates to the outside world either through visible contacts or through RF. Smart cards, with their inherent security and data storage, are an ideal platform on which to store and manage cardholder information for applications such as identification, credit/debit, customer loyalty, health, transportation.

### BACKGROUND OF THE INVENTION

Companies and government agencies desiring to deploy smart card solutions face the challenge of working with multiple smart card architectures and data encoding techniques. Several standards exist and others are currently evolving for encoding cardholder demographic data within the smart card's memory. These approaches are not interoperable with each other. Current card based applications are typically programmed to recognize and manage only one a single card architecture. This limitation discourages cross-organizational use of smart cards.

Different data layouts mean that data items such as cardholder name and address will have different physical locations on smart cards formatted by different issuers. As well, different encoding schemes include variations on TLV (tag, length, value) attributes, different sequential order, EOC bytes, security measures, and file headers and suffixes.

Because these approaches are different, data from a valid card cannot be read even by a system that has been programmed to physically communicate with a smart card from a specific manufacturer. Encoding the card data in multiple data formats is not feasible either. Smart cards are subject to space limitations and redundant data on the card will compromise data integrity. Even within the Federal Government's smart card initiative there are multiple possible data layout schemes. It currently is not possible to use a GSA-encoded smart card at the Pentagon where typically only the CAC data format is recognized by DOD applications.

### DESCRIPTION OF THE PRIOR ART

U.S. Pat. No. 6,213,392 to Zuppicich discloses methods to transmit low level byte exchanges between an application, card, and reader. It doesn't address the need for card data models or provide a means for similar applications to manage different card structures.

U.S. Pat. No. 6,199,762 to Hohle is concerned with the security of initializing a card and the management of systems in a distributed environment. It makes no claims for handling multiple card data structures.

Although U.S. Pat. No. 5,889,941 to Tushie does mention a card issuer data format template, it is only within the context of card issuance and is too low-level to be considered an application data model. Further, it does not anticipate that fielded applications can be configured to adapt to different card architectures.

### SUMMARY OF THE INVENTION

It is therefore an object of the present invention to provide a universal means to prepare/format and read/interpret smart card data architectures.

A first aspect of the present invention is to translate a smart card architecture into an application template that will model how and where data is encoded on a particular card type.

A second aspect of the present invention is to manage the application templates to ensure that a “best match” will be selected thereby making available to the host application the entire card map.

A third aspect of the present invention is for the application templates to provide sufficient flexibility to integrate complex encoding and data layout schemes for new and concurrently developing card applications.

A fourth aspect of the present invention is to create interoperability so that smart cards from different manufacturers can be formatted and programmed without regard for low-level card instruction sets.

A fifth aspect of the present invention is that support for new/revised card schemes can be added to existing applications by simply distributing a new application template.

These and other aspects of the present application will become more readily apparent from the attached drawings and detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 illustrates the construction of an application template file.

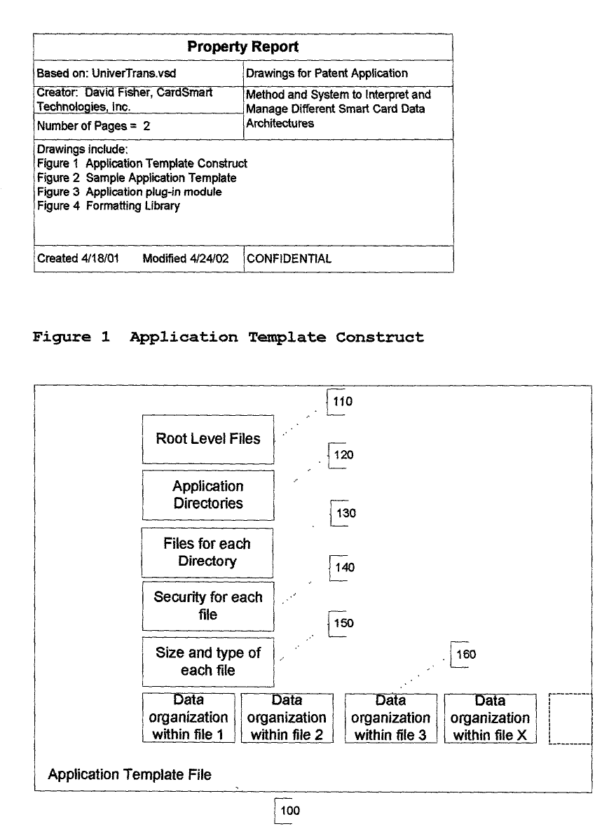

FIG. 2 provides an example of an application template file.

FIG. 3 illustrates the components of a plug-in library that will use application templates in order to communicate with known types of cards.

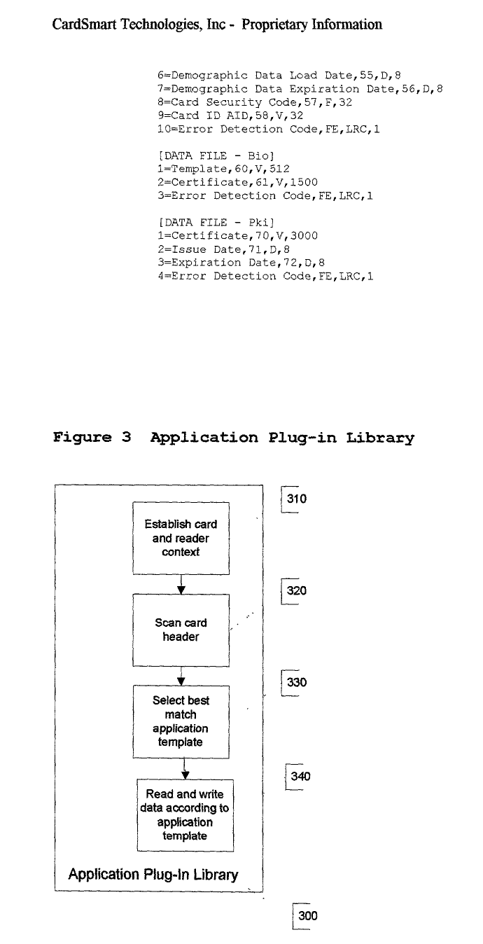

FIG. 4 illustrates the components of a card formatting library that will use application templates to create different smart card architectures.

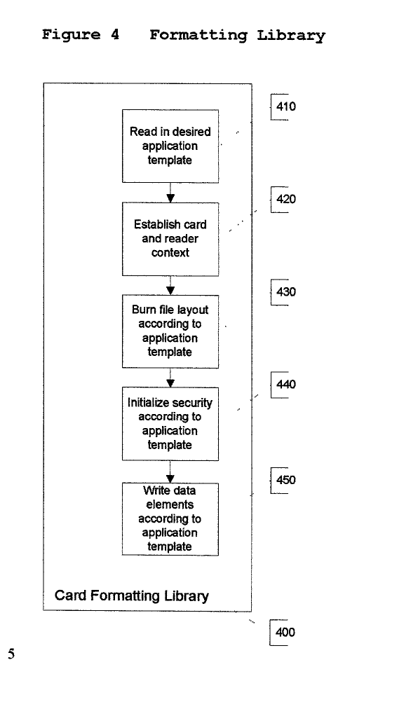

The present invention will become more fully understood from the detailed description given below.

### DETAILED DESCRIPTION OF THE INVENTION

This invention discloses a data mapping process and the corresponding system to manage smart card data architectures according to this mapping. The data mapping process will generate an application template 100 which describes what data elements are present on the card, where they are located, who owns the rights to each data element, what security provisions may be in place, and other attributes about specific encoding techniques. For each possible card layout a different application template must be generated. These application templates exist as data files external to the card. At a minimum, each application template has the following sections:

[Root Description]

Identifies the contents of the root level files 110.

[Data Files]

This section identifies each of the card files that may contain cardholder information 130. File size and associated security conditions are also detailed. The specific format for each data file is:

AbbreviatedName(nnn)=FamiliarName, FileID, Length, SecurityAccessForRead, SecurityAccessForWrite

[File nnn]

There will be a separate section for each card file identified in the Data Files section. Within each of these sections the precise organization of the data 160 is described through a TLV format. The specific format for each data element is:

FamiliarName, TagIdentifier, DataType, Length

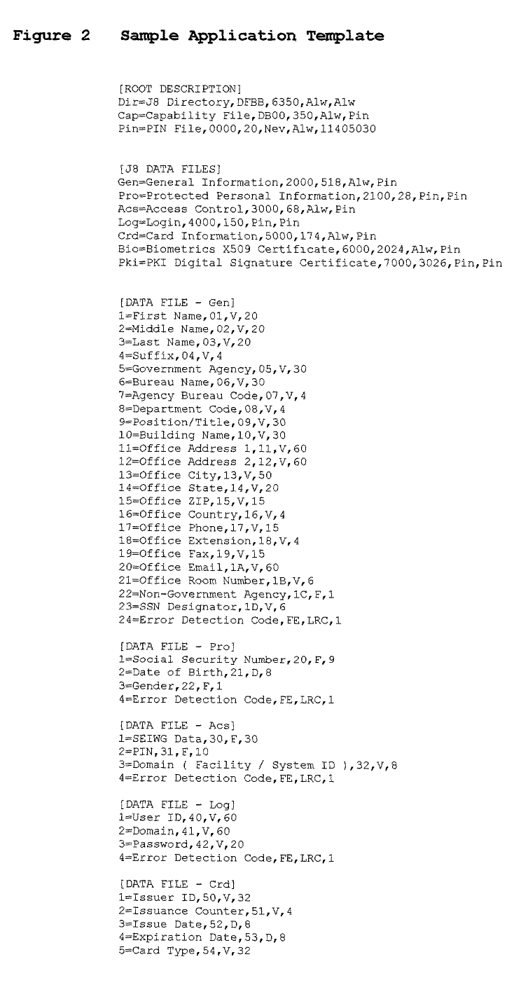

By way of example a complete application template is illustrated in FIG. 2. With this as a guide, cardholder demographic information such as name, address, phone number and other pertinent data can be extracted from any card for which a mapped application template has been created.

Even existing smart card programs can make use of these application templates. An application plug-in module 300 will form the software bridge between a smart card application and the many possible smart card data formats. This module will exist as a library of compiled code with published functions that can be called from a higher level application. First, this module will establish a card and reader context 310 and then obtain some general information from the card 320. The module will then attempt to recognize the type of card and encoding style using pattern matching against the known application templates 330. Once the module has determined the correct match then the entire data mapping can be processed 340. Existing programs will need to be changed only slightly in order to work with this plug-in module. New or revised card types can now be supported by simply distributing the new corresponding application template file.

A code library for card formatting 400 can easily create any card structure for which there exists an application template 410. First the basic card structure 430 is burned to the chip, followed by the security scheme 440. Finally, the data elements are written 450 to the just created structure.

By way of specific example consider that the federal government has endorsed at least two different data layout systems for smart cards. These are the CAC and GSA/J8. The disclosed invention requires that an application template mapping be created for each. These application templates are then distributed along with the a plug-in module to all smart card programs. In this manner, any federal government smart card ID (whether CAC or J8) will work at any federal government location.

Even network-based programs can benefit. In a web form fill screen, cardholder information is read from a smart card and is used, in turn, to populate a survey form. By integrating the described plug-in module and application templates, any known smart card could be used to seamlessly populate the demographic data requested by the form.

What is claimed is:

1) A method for describing a smart card data architecture into a representative model termed an application template. Application templates are interpreted by smart card programs to manage multiple data structures.

2) Method of claim 1 wherein the organization of the data elements can be dynamically modified through simple edits to the application template file.

3) Method of claim 1 wherein the application template accurately describes encoding schemes and security considerations.

4) Method of claim 1 wherein the application template is in a portable format.

5) Method of claim 1 wherein application templates can describe known data models as well as data models that are concurrently developing or are not yet conceived.

6) System to manage the application templates that comprises the following steps:
Establish card and reader context
Scan in the card header
Conduct a “best match” search of available application templates
Utilize the selected application template to continue exchanges with the card.

7) System of claim 6 packaged as a plug-in module for distribution to applications that need to work with differently formatted smart cards.

8) A computer program embodied on a computer-readable medium for formatting smart cards according to an application template, comprising:
a code segment for establishing a communication link between the host and the card and reading device.
a code segment for reading and interpreting the application template file.
a code segment for formatting the organizational structure to the card conforming to the application template.
a code segment for initializing the card security.
a code segment for transmitting data elements into the structure.

9) A computer program as recited in claim 8, such that the low level interface to the card and reader including the details of smart card architectures and encoding processes are transparent to the user.

10) A computer program as recited in claim 8, such that support for new card schemes can be added by simply distributing an application template file for the new card type.
